(19) United States
(12) Patent Application Publication
(10) Pub. No.: US 2008/0298330 A1
(43) Pub. Date: Dec. 4, 2008

(54) Using Presence Detection To Control A Wireless Network

(75) Inventor: Adam Leitch, Reigate/Surrey (GB)

Correspondence Address: PHILIPS INTELLECTUAL PROPERTY & STANDARDS, P.O. BOX 3001, BRIARCLIFF MANOR, NY, 10510, US

(73) Assignee: ASAHI KASEI CHEMICALS CORPORATION, TOKYO (JP)

(21) Appl. No.: 12/097,312

(22) PCT Filed: Dec. 8, 2006
(86) PCT No.: PCT/IB06/54708

§ 371 Date: Jun. 13, 2008

(30) Foreign Application Priority Data
Dec. 19, 2005 (EP) 05112360.2

(51) Int. Cl. H04Q 7/24

(52) U.S. Cl. 370/338

(57) ABSTRACT

A wireless system coupled to a local area network (LAN) (101). The wireless system provides wireless network services to a wireless communication device disposed in an area within which the wireless system is deployed. A presence detector (301, 302, 303, 304) detects a presence of a user within a detection area. A wireless communication node (201, 202, 203, 204) is operably coupled to the LAN (101) and the presence detector (301, 302, 303, 304). When the presence detector (301, 302, 303, 304) detects the presence of the user within the detection area, the wireless communication node (201, 202, 203, 204) is enabled to provide wireless network services to the wireless communication device.

The present invention relates to systems and methods for control of wireless networks.

Recently as the hardware cost of wireless networks based on the IEEE 802.11 standard (widely known as Wi-Fi) continues to fall, they become more popular and are often proposed for additions to established local area networks. An article entitled “A Probabilistic Room Location Service for Wireless Networked Environments,” by Paul Castro et al., (“the Castro Article”) appearing in Proceedings of the 3^{rd} International Conference on Ubiquitous Computing, 2001, incorporated by reference herein as if set out in its entirety, states that “[t]hese products offer good bandwidth and affordability for office buildings, university campuses, and homes.”

One feature of a wireless network is the ability to infer a location of a wireless client from signal quality measures, e.g. for interaction with or control of nearby computers, displays, printers, and electronic post-it notes associated with a location. Similar to most existing location based systems, detecting the location of a device requires special hardware. The Castro Article discusses several ways for obtaining location information, such as deploying an infrared transceiver system and commercially available GPS.

In wireless environments, such as wireless fidelity systems (Wi-Fi) environments, it is possible to use software to infer the location of a wireless networked device by analyzing the signal strength or signal-to-noise ratio of the wireless access point with respect to that device. By using such software, no additional hardware needs to be attached to a laptop or personal digital assistant (PDA) beyond a wireless network PC card that may be required to send and receive a Wi-Fi signal. One technique that may be applied to infer the location of a wireless device is multilateration. Multilateration is a fixing of a position by reference to a time difference of arrival of a signal at a collection of sensors, using, for example, radio frequency or ultrasound. A nearest neighbor system may be utilized for Wi-Fi network clients that are primarily associated with access points. The access points act as bridges between the wireless network and a local LAN that provides the Wi-Fi network clients with a strongest received signal. In this system, as a wireless client travels, the wireless client periodically performs a site survey of signal quality measures to determine the best access point with which to associate. It is possible to infer a location of the Wi-Fi network client from the signal measures.

A U.S. Patent Publication No. 2005/0097356 (“the '356 Publication”), incorporated by reference herein as if set out in its entirety, discloses enabling a wireless device to resume a connection with a wireless network after an interruption (e.g., after the wireless device has left a coverage area). In operation, the wireless network requests information from the wireless device, receives the information, transmits a coded identifier (containing an IP address) mapped to the wireless device, and establishes a short-range communication link with the wireless device to maintain and resume a service session after the wireless device returns to the coverage area.

Inferring a location of a wireless device communicating with a wireless network is also closely related to security of such networks. Particularly, easy access to a wireless network and a possibility to monitor traffic being broadcast within the network creates a possibility for substantial problems and damages to the corporations and other organizations adopting the Wi-Fi technology. Naturally, these organizations seek means and approaches to solve the problems including security problems associated with deploying a wireless network.

A publication entitled, “Rogue Detection and Blocking,” by Dev Anand (“the Anand Publication”), published as an Adventnet Technical Whitepaper on the Internet at manageengine.adventnet.com/products/Wi-Fi-manager/rogue-detection-and-blocking-whitepaper.html, incorporated by reference herein as if set out in its entirety, recognizes numerous problems associated with deploying a wireless network. The Anand Publication states that rogue detection and blocking is a continuous process involving at least a dedicated piece of hardware (sensor) to monitor the air and identify network behavior, a central IDS engine that gathers inputs from many sensors and helps in pinpointing a device as rogue, and network management software that communicates to the wired network to identify a switch port to which a potential rogue access point is connected to enable shutting down the port. Most wireless network detecting systems use radio frequency (RF) scanning. In operation, special RF sensors are plugged into the wired network to perform packet capture and analysis to detect a wireless device operating in the area and to alert the LAN administrator.

Implicit in all wireless networks is an ability to uniquely identify a mobile device and/or a user of the mobile device to enable coherent wireless communication. This ability to identify the mobile device may also be utilized as a means for restricting access to a wireless node. For example, access to the node may be restricted to identified and recognized mobile devices and/or users. A further discussion of identifying and recognizing mobile devices is beyond the scope of the present discussion.

Another publication entitle “Rogue Access Point Detection using Temporal Traffic Characteristics,” by Raheem Beyah et al. (“the Beyah Publication”), published at IEEE GLOBECOM '04, Global Telecommunications Conference, 2004. Volume 4, December 2004, incorporated by reference herein as if set out in its entirety, describes a method for using of temporal traffic characteristics to detect rogue access points at a central location. This detection is independent of the wireless technology and is based upon a comparison of the data traffic speed between wired and wireless links and further analysis of frequency response characteristics of inter-packet spacing. The method discussed in the Beyah Publication is said to allow detection of rogue access points.

The recent trends in development of wireless networks are often directed to augmenting existing LANs and reducing the cost of deploying and maintaining the network structure, as well as providing security measures to protect the networks from unauthorized use.

It is also well known that many corporate buildings have lighting systems that are switched dynamically using so-called presence detectors. These lighting systems are normally situated in the ceiling, and monitor an area beneath them. Typically, the presence detectors are formed into a “grid” pattern and control one or several local lights, and thus when a users walks, sits, or is generally positioned within an office building, the relevant local lights are automatically switched on. This provides savings on electricity costs to the building owner, and is also considered more “environmentally friendly” in that electrical resources are not wasted by lighting areas where users are not present.

It is an object of the present system to overcome disadvantages in the prior art.

The present system provides a system and method for using presence detection capabilities that may be incorporated into lighting systems to enable controlling wireless network nodes and thereby, reduce costs of network connections, as well as improve network security. Other aims of the invention will become apparent from a consideration of the drawings, ensuing description, and claims as hereinafter related.

The present system therefore proposes a novel and unobvious way for costs reduction and increased security of networks by means of optimal use of wireless and wired network nodes. The present system detects and analyzes a presence, including foot traffic of users in an organization building or an office space. The detection of users may be provided by the use of a dedicated presence detector and/or existing presence detectors that are coupled with lighting systems that are part of an existing building's infrastructure. Thus, the in accordance with an embodiment of the present system, presence detectors may share detection information between the lighting system and the wireless network.

In accordance with the present system, a wireless system is operably coupled to a local area network (LAN). The wireless system provides wireless network services to a wireless communication device disposed in an area within which the wireless system is deployed. A presence detector detects a presence of a user within a detection area. A wireless communication node is operably coupled to the LAN and the presence detector. When the presence detector detects the presence of the user within the detection area, the wireless communication node is enabled to provide wireless network services to the wireless communication device.

In an embodiment of the present system, a light source shares a use of the presence detector with the wireless system and if the presence detector detects the presence of the user within the detection area, the light source is enabled to provide lighting. The light source and/or the wireless communication node may be one of a plurality of such devices that respectively operate as a lighting and/or wireless network. In another embodiment, the presence detector identifies the user that is within the detection area and bandwidth is allocated based on the identity of the user. Further, the wireless communication node may allocate bandwidth based on a total number of users that are identified to be within the detection area. The wireless communication node may provide wireless network services as determined by a plurality of rules. The system may also monitor user activity within the detection area over time and generate rules based on the user activity. The wireless communication node may enter a security state when the presence detector does not detect the presence of a user within the detection area. The wireless communication node may generate a security signal if communication with the wireless communication node is attempted during the security state.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those of ordinary skill in the art that other embodiments that depart from these specific details would still be understood to be within the scope of the appended claims. Moreover, for the purpose of clarity, detailed descriptions of well-known devices, circuits, and methods are omitted so as not to obscure the description of the present invention.

It should be expressly understood that the drawings are included for illustrative purposes and do not represent the scope of the present system. In the accompanying drawings, like reference numbers in different drawings designate similar elements.

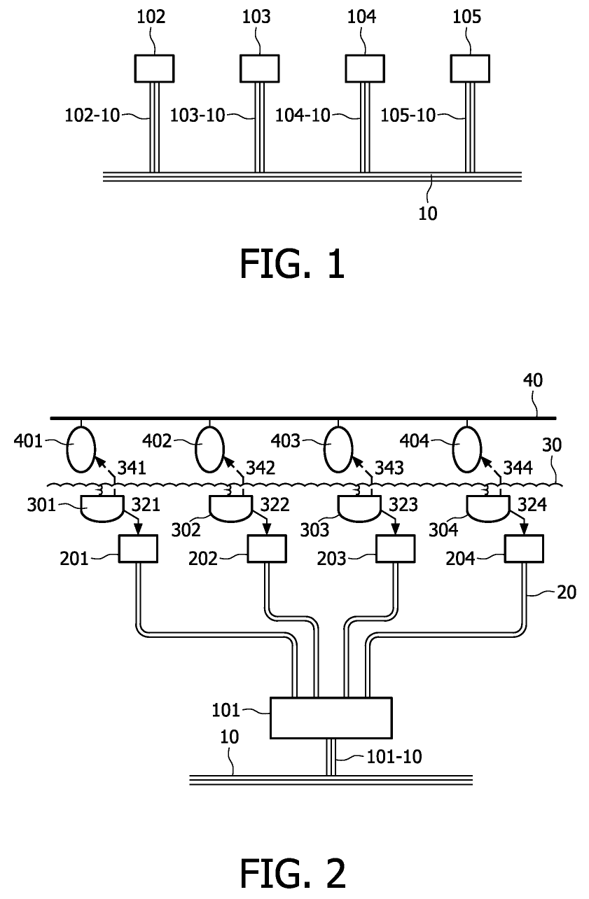

FIG. 1 is a structural view of a prior network node wired to a backbone LAN;

FIG. 2 is a structural view of a wired and wireless LAN joined to a lighting system with presence detection control in accordance with an embodiment of the present system;

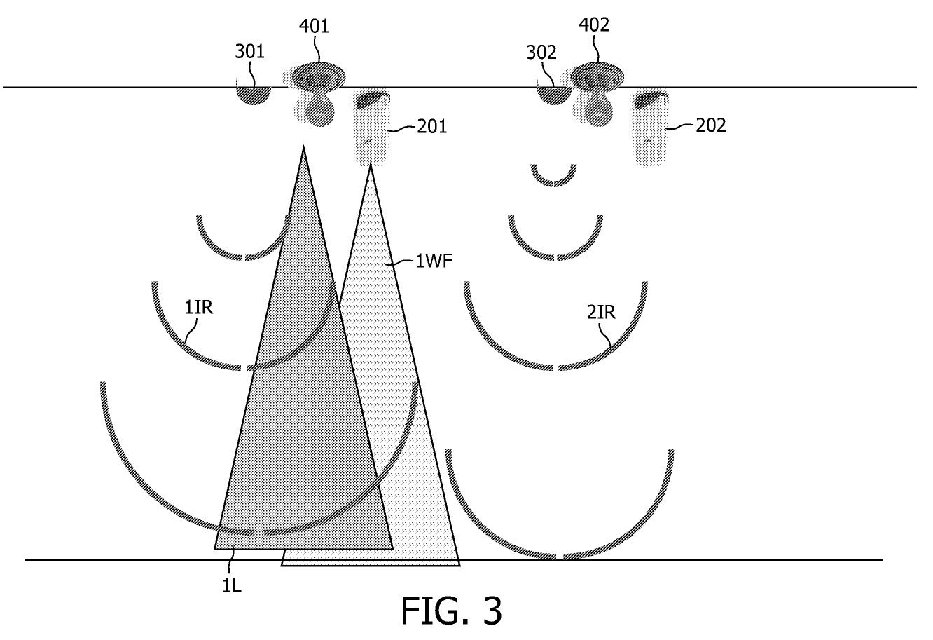

FIG. 3 is a view of two neighboring device groups each including a presence detector, wherein the first group detects foot traffic in accordance with an embodiment of the present system; and

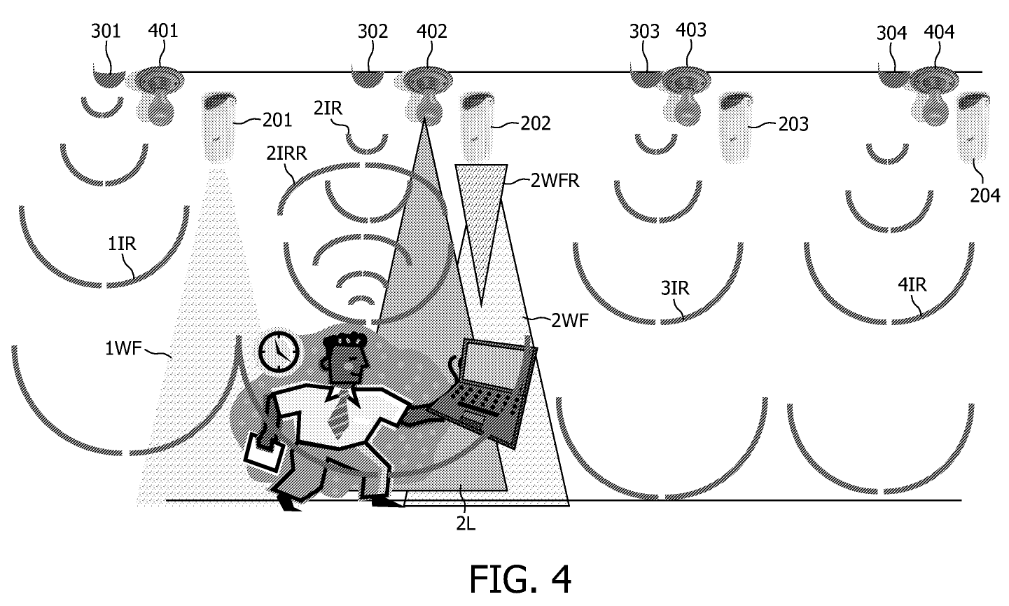

FIG. 4 is a view of four neighboring device groups, each including a presence detector, wherein the second group detects foot traffic moving from the first to the second group in accordance with an embodiment of the present system.

FIG. 1 illustrates a backbone network 10, and network nodes 102, 103, 104, 105 connected to the backbone network 10 in a traditional way by hardwired connections, namely node cables 102-10, 103-10, 104-10, 105-10. Typically the node cables 102-10, 103-10, 104-10, 105-10 are rented or licensed on a “per-connection” basis. In this system, the number of node cables utilized is generally equal to the number of network connections.

FIG. 2 shows an embodiment in accordance with the present system depicting a backbone network 10 connected to a backbone node 101, which may be a main floor switcher or router. The backbone node 101 is shown connected to the network 10 through a connection 101-10. The backbone node 101 generally has a predetermined bandwidth that may be used for a number of wireless broadcast channels. There is provided a number of local wireless nodes 201, 202, 203, 204, which number generally, in accordance with an embodiment of the present system, may be greater than a number of broadcast channels. The local nodes 201, 202, 203, 204 are each operably connected to the backbone node 101, such as respectively hardwired to one of local cables 20, although any operable connection may be utilized, such as a wireless connection, etc. In operation, instead of bringing multiple backbone cables, one to each local node, as in a traditional LAN, just a single cable, such as connection 101-10, may be installed and utilized.

The nodes 201, 202, 203, 204 represent a wireless network system, such as Wi-Fi, and may be situated throughout a floor area in different locations, such as within corridors, offices, waiting rooms, meeting rooms, etc. The nodes 201, 202, 203, 204 are used to provide convenient wireless connections, mostly by means of RF or another suitable medium, with laptop computers, PDAs, and similar consumer devices. Each node 201, 202, 203, 204 generally has an antenna with a broadcast zone associated with the node, wherein a wireless connection with the consumer device may be established.

The embodiment shown in FIG. 2 includes a conventional electrical lighting grid 40 that powers a plurality of light sources 401, 402, 403, 404. Presence detectors 301, 302, 303, 304 are shown operably interconnected through connection 30, which illustratively may be physical wiring and/or a wireless connection. The presence detectors may use IR radiation, visual imaging such as used by a camera, or any other suitable system enabled to detect a presence of one or more users within a predetermined zone, illustratively called a detection zone, associated with one or more presence detectors. The presence detectors may be operable to switch on/off or regulate an intensity of light sources 401, 402, 403, 404 depending on the presence of one or more users or user movement (e.g., foot traffic) within the detection zone. This switching/regulating may be provided through light regulation signals 341, 342, 343, 344 transmitted between the presence detectors and corresponding light sources (e.g., between presence detector 201 and light source 401). Any or each of presence detectors 301, 302, 303, 304 and nodes 201, 202, 203, 204 may include a processor (e.g., central processing unit, CPU) having a memory for storing a program that is executed by the CPU to enable the present system to operate as described.

According to an embodiment of the present system, the presence detectors 301, 302, 303, 304 may also provide presence indication signals 321, 322, 323, 324 to the local nodes 201, 202, 203, 204, as shown on FIG. 2. Illustratively, in the embodiment shown, detector 301 is associated with node 201; detector 302 is associated with node 202, and so on. As mentioned above, each presence detector is associated with a detection zone, whereas each local wireless node is associated with a broadcast zone. In one embodiment, the broadcast zone of a local node may be arranged to span the detection zone of the presence detector corresponding to the local node. In other embodiments, the broadcast zone may be arranged to correspond to or be larger than a corresponding detection zone. For example the broadcast zone may be arranged to span a number of detection zones. For example, a broadcast zone of node 202 may illustratively be arranged to span a detection zone of presence detectors 301, 302, 303. In another embodiment, the detection zone may be arranged to correspond to or be larger than a corresponding broadcast zone. For example, multiple nodes may be utilized to span an area covered by a detection zone when the nodes are operating, for example, within a piconet.

The presence detection signals may be used by a wireless network system (e.g., such as networked nodes 201, 202, 203, etc.) for allocation of broadcast channels and enabling/disabling the wireless broadcast between the local wireless nodes and consumer devices, depending on the detection information of the presence detectors. Algorithms or rules may be utilized for processing the detected information, as is discussed in more detail below. In some embodiments, the allocation/enabling/disabling may include an algorithm utilizing detection information from any presence detectors that pertain to the lighting system, whereas in other embodiments only the detection information supplied by the presence detectors associated with a particular wireless node may be utilized.

In different embodiments, the local nodes may be co-located with the presence detectors, or co-located with the light fittings, or may be embedded in separate units and distanced form each other as desired to enable transmission to and from a user device.

In another embodiment of the system, a number of users and a number of connections already used may be determined to identify how many connections to the network are desired to enable a continuous connection to the network for current users and potential future users, such as users passing through an area or present in the area. Current usage of the nodes may be monitored and rules created for enabling user access to nodes. For example, although foot traffic may be present on a particular corridor, it may only be to a cupboard for cleaning staff. In this case, the system may refuse a request for a node in such an area or may generate a security alert, should a node be requested in such an area. The rules may be generated during a “learning” mode of the system. Should a node be activated, or network traffic on such a node continue after foot traffic has ceased or a user is no longer present in the area, this may be learned by the current system as an indication that a foreign device is interfacing with the system, and a security alert may be generated.

A decision to allocate bandwidth and communication channels of a node and to enable a wireless local node may be provided using a variety of rules. Illustrative examples of rules may include, that a node continues to broadcast for a fixed duration after a user walks under a presence detector to enable the user utilizing the node to pass through the broadcast zone of the node and possibly to pass on to another broadcast zone of another node; a node may continue to broadcast and/or be accessible to a user while the user is immediately within a detection zone of the detector; a node may be enabled when neighboring lights are activated; and a node may be enabled based on “typical” daily activity. For example, a node may be activated by the arrival of a first person into an area. A typical daily activity for an area like a call center may be that a majority of users work regular shifts and typically arrive within a few minutes of each other. Accordingly, if 100 users work in such an office area, a rule utilized in accordance with the present system may include that upon an arrival of a first user, all nodes are activated, as all nodes may typically be required within a few minutes of the arrival of the first user.

User tracking may be deployed to predict a location of a next node that may be required by a user. For example, a user via user equipment (PC, PDA, etc.) may be utilizing node 203 and be detected to be moving in a direction of node 202, either by a determination that the user previously was utilizing node 204 and/or by a pattern of received transmissions from the user equipment. For example, a weak received signal received at node 203 from the user equipment that goes to a strong signal and then diminishes to a weak signal may be a pattern indicating the user is passing through a broadcast zone.

In another embodiment “umbrella” nodes may be utilized, in which moving users (e.g., walking, running, etc.) are provided a larger broadcast zone from a node with higher power output than may be typical, so that less node changeovers may be required for that moving user.

A rule may be provided for particular rooms or areas. For example, in a meeting area, when a first user arrives in the meeting area, additional node bandwidth may be allocated automatically, thus when other users arrive, connections may be already available. In additional, individual users, or consumer devices may be assigned a profile, thus an IT manager, as identified by the IT manager's equipment and/or other identifying equipment, such as a radio frequency identification tag (RFID), may typically have several connections available, whereas a secretary may only typically have one connection available.

A security feature may be provided to enable connections for an identified “guest” or “customer” only while they are within a broadcast zone of specific nodes. This may ensure that the guest or customer is not provided network coverage in sensitive areas, such as in an engineering area.

In another embodiment, user devices may be allocated a profile (e.g., a set of rules), dependent on characteristics of the user devices. For example, a laptop may be provided access to a single node within a detection zone, whereas a PDA, which is a device that a user may travel with much faster than with a laptop, may have nodes enabled within a specific number of meters from a current location of the PDA, or for example, may even be enabled for connecting to any node on an entire floor. In one embodiment, foot traffic detected by corridor detectors in one area may be utilized for enabling nodes situated in an office area located off the corridor.

As should be clear from all of the above examples, in accordance with the present system, presence detectors are utilized, in some embodiments together with an identification of an identity of a user, and/or the users equipment, to determine whether a local node may be required. The current system enables a limited amount of bandwidth to be dynamically allocated to different parts of an area automatically.

In operation, a backbone node, such as backbone node 101, shown in FIG. 2, does not need a mapping or a complex rule structure for operation of the wireless system. In accordance with the present system, simple feedback from presence detectors 301, 302, 303, 304 indicating an amount of foot traffic and users present in given detection zones is sufficient for dynamic operation of the wireless system.

FIG. 3 illustrates two neighboring groups of devices in accordance with an embodiment of the present system. The first group includes local wireless node 201, presence detector 301, and light source 401. The second group respectively includes local wireless node 202, presence detector 302, and light source 402. Two pluralities of semi-circles 1IR and 2IR represent infrared signals transmitted respectively by presence detectors 301 and 302. In operation, the presence detector 301 may detect a person entering into a detection zone represented by semicircle 1IR (e.g., foot traffic). The presence detector 301 may then activate the light source 401 thereby, creating lighting 1L. In accordance with an embodiment of the present system, the presence detector 301 may also enable the wireless node 201, to enable (in case of a Wi-Fi network—via a Wi-Fi antenna) a network broadcast substantially distributed within a broadcast zone 1WF. Detector 302, transmitting signals 2IR, detects no foot traffic, and thus doesn't activate light source 402 and doesn't enable wireless node 202, thereby reserving potential bandwidth for use in another area.

FIG. 4 illustrates four neighboring groups of devices. The groups include correspondingly local wireless nodes 201, 202, 203, 204; presence detectors 301, 302, 303, 304, and light sources 401, 402, 403, 404 operably coupled together as described above. Similarly to FIG. 3, each presence detector 301, 302, 303, 304, transmits respective signals 1IR, 2IR, 3IR, 4IR. An office worker is depicted in FIG. 4 crossing the room, walking from left to right, carrying a laptop. The worker is shown having already passed the zone of detector 301 and accordingly, is no longer detected by detector 301. The light source 401 accordingly is shown off, having decayed back to zero. The transition/decay for light sources may be sudden on to off, or light sources may dim from a full on state to an off state. The node 201 may remain enabled for a short time after the presence detector 401 no longer detects the worker to provide a smooth transfer to the next broadcast zone of node 202. Any of a variety of techniques may be deployed to continue a wireless session from one node to another, including similar techniques as used for transfer of cellular communications from one cell to another, and techniques used for Wi-Fi transfer from one node to another.

As shown in FIG. 4, the worker is positioned under the light source 402, and is detected by the detector 302, that illustratively detects infrared signals 2IRR from the user. Accordingly, detector 302 activates light source 402 to produce lighting 2L, and activates node 202 to enable potential network broadcast 2WF and receiving wireless communication signals 2WFR transmitted by the worker's laptop. Since detectors 303 and 304 detect no foot traffic, light sources 403 and 404 are not yet activated and being off, nodes 203 and 204 are not enabled.

While the above description has identified particular features and elements, these features and elements are merely intended to facilitate illustrative embodiments of the present system. For example, while presence detectors are illustratively discussed as IR transmitting presence detectors, other types of presence detectors may also be suitably utilized including IR receivers that detect a change in received heat radiation, motion sensors, sound detectors, camera's, etc.

Having described embodiments of the invention with reference to the accompanying drawings, it is to be understood that the invention is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

1. A wireless system operably coupled to a local area network (LAN), and configured to provide wireless network services to a wireless communication device disposed in an area within which the wireless system is deployed, the wireless system comprising:
a presence detector (301, 302, 303, 304) configured to detect a presence of a user within a detection area; and
a wireless communication node (201, 202, 203, 204) operably coupled to the LAN and the presence detector (301, 302, 303, 304), wherein if the presence detector (301, 302, 303, 304) detects the presence of the user within the detection area, the wireless communication node (201, 202, 203, 204) is enabled to provide wireless network services to the wireless communication device.

2. The system of claim 1, comprising a light source (401, 402, 403, 404), wherein if the presence detector (301, 302, 303, 304) detects the presence of the user within the detection area, the light source (401, 402, 403, 404) is enabled to provide lighting.

3. The system of claim 1, wherein the wireless communication node (201, 202, 203, 204) is configured to provide wireless network services within a broadcast zone that substantially overlaps the detection area.

4. The system of claim 1, wherein the wireless communication node (201, 202, 203, 204) is configured to provide wireless network services within a broadcast zone that substantially does not overlap the detection area.

5. The system of claim 1, wherein the presence detector (301, 302, 303, 304) is configured to identify the user and wherein the wireless communication node (201, 202, 203, 204) is configured to allocate bandwidth determined by the identity of the user.

6. The system of claim 1, wherein the presence detector (301, 302, 303, 304) is configured to identify a number of users within the detection area and wherein the wireless communication node (201, 202, 203, 204) is configured to allocate bandwidth determined by the number of users.

7. The system of claim 1, wherein the wireless communication node (201, 202, 203, 204) is configured to provide wireless network services determined by a plurality of rules.

8. The system of claim 7, wherein the rules comprise at least one of:
a) the node is enabled to provide wireless network services for a fixed duration of time after the user has left the detection area;
b) the node is enabled based on typical user activity within the detection area;
c) the node is enabled to allocate bandwidth based on a profile of an area including the detection area.

9. The system of claim 1, wherein the wireless communication node (201, 202, 203, 204) is configured to enter a security state when the presence detector does not detect the presence of the user within the detection area.

10. The system of claim 9, wherein the wireless communication node (201, 202, 203, 204) is configured to generate a security signal if communication with the wireless communication node (201, 202, 203, 204) is attempted during the security state.

11. A method of providing wireless access by wireless communication devices to a local area network, the method comprising the acts of:
detecting if a user is within a detection area; and
enabling a wireless communication to access the network in response to detecting that the user is within the detection area.

12. The method of claim 11, comprising the act of enabling a light source to provide lighting in response to detecting that the user is within the detection area.

13. The method of claim 11, comprising the acts of:
identifying the user; and
allocating bandwidth determined by the identity of the user.

14. The method of claim 11, comprising the acts of:
identifying how many users are within the detection area; and
allocating bandwidth determined by how many users are within the detection area.

15. The method of claim 11, wherein enabling wireless communication comprises the acts of:
identifying if a user detected within the detection area satisfies a rule; and
enabling the wireless communication determined by the satisfied rule.

16. The method of claim 15, comprising the acts of:
identifying repetitive behavior of users within the detection area over a period of time; and
creating a rule determined by the identified repetitive behavior.

17. The method of claim 11, wherein enabling wireless communication comprises the acts of:
identifying if a user detected within the detection area satisfies a security rule; and
generating a security signal determined by the satisfied security rule.

18. The method of claim 11, comprising the act of entering a security state when a user is not detected within the detection area.

19. The method of claim 17, comprising the act of generating a security signal if communication is attempted during the security state.
